(19) United States
(12) Patent Application Publication
(10) Pub. No.: US 2026/0238901 A1
(43) Pub. Date: Aug. 13, 2026

(54) PHOTOELECTRIC CONVERSION APPARATUS AND PHOTOELECTRIC CONVERSION SYSTEM

(71) Applicant: CANON KABUSHIKI KAISHA, Tokyo (JP)

(72) Inventors: TOMOYA SASAGO, Kanagawa (JP); YASUHARU OTA, Tokyo (JP)

(21) Appl. No.: 19/535,026

(22) Filed: Feb. 10, 2026

(30) Foreign Application Priority Data
Feb. 12, 2025 (JP) 2025-020991

(51) Int. Cl. H04N 25/773; H04N 25/767; H04N 25/79

(52) U.S. Cl. CPC H04N 25/773; H04N 25/767; H04N 25/79

(57) ABSTRACT

A photoelectric conversion apparatus includes a plurality of APDs, a first control circuit configured to set the plurality of APDs in a photon-detectable state in accordance with a first control signal, a plurality of shaping circuits supplied with outputs of the plurality of APDs, respectively, a logic circuit configured to generate a second control signal by calculating a logical sum of outputs of the plurality of shaping circuits, a counter configured to perform a count operation in a case where the second control signal is generated, and a second control circuit configured to set the plurality of APDs in an avalanche non-occurrence state in a case where the second control signal is generated.

### BACKGROUND

### Field of the Technology

The present disclosure relates to a photoelectric conversion apparatus and a photoelectric conversion system.

### Description of the Related Art

Japanese Patent Laid-Open No. 2021-197596 describes a photoelectric conversion apparatus including two APDs, two inverters that shape outputs of the two APDs, respectively, an OR circuit that calculates a logical sum of outputs of the two inverters, and a counter that counts the output of the OR circuit. The photoelectric conversion apparatus further includes a switch that quenches avalanche multiplication of the two APDs if the output of the counter reaches a predetermined value.

In the photoelectric conversion apparatus described in Japanese Patent Laid-Open No. 2021-197596, in a period during which avalanche multiplication occurs in one of two APDs and the counter counts it, if a photon enters the other APD, avalanche multiplication also occurs in the other APD. However, the counter does not count the occurrence of avalanche multiplication in the other APD during this period. Therefore, the occurrence of avalanche multiplication in the other APD merely consumes power and is wasteful.

### SUMMARY

The present disclosure provides a technique advantageous in reducing power consumption.

The present disclosure provides a photoelectric conversion apparatus comprising: a plurality of APDs; a first control circuit configured to set the plurality of APDs in a photon-detectable state in accordance with a first control signal; a plurality of shaping circuits supplied with outputs of the plurality of APDs, respectively; a logic circuit configured to generate a second control signal by calculating a logical sum of outputs of the plurality of shaping circuits; a counter configured to perform a count operation in a case where the second control signal is generated; and a second control circuit configured to set the plurality of APDs in an avalanche non-occurrence state in a case where the second control signal is generated.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the arrangement of a photoelectric conversion apparatus according to an embodiment;

FIG. 2 is a view showing an example of the arrangement of the first substrate;

FIG. 3 is a view showing an example of the arrangement of the second substrate;

FIG. 4 is a view showing the arrangement of a unit circuit of a photoelectric conversion apparatus according to the first embodiment;

FIG. 5 is a timing chart for explaining a photon detection operation in the photoelectric conversion apparatus or the unit circuit according to the first embodiment;

FIG. 6 is a view showing the arrangement of a unit circuit of a photoelectric conversion apparatus according to the second embodiment;

FIG. 7 is a view showing the arrangement of a unit circuit of a photoelectric conversion apparatus according to the third embodiment;

FIG. 8 is a timing chart for explaining a photon detection operation in the photoelectric conversion apparatus or the unit circuit according to the third embodiment;

FIG. 9 is a view showing the arrangement of the unit circuit of the photoelectric conversion apparatus according to a modification of the third embodiment;

FIG. 10 is a view showing the arrangement of a unit circuit of a photoelectric conversion apparatus according to the fourth embodiment;

FIG. 11 is a timing chart for explaining a photon detection operation in the photoelectric conversion apparatus or the unit circuit according to the fourth embodiment;

FIG. 12 is a view showing the arrangement of a unit circuit of a photoelectric conversion apparatus according to the fifth embodiment;

FIG. 13 is a view showing the arrangement of the second substrate constituting the photoelectric conversion apparatus according to the fifth embodiment;

FIG. 14 is a view showing the arrangement of the third substrate constituting the photoelectric conversion apparatus according to the fifth embodiment;

FIG. 15 is a view showing the arrangement of a unit circuit of a photoelectric conversion apparatus according to the sixth embodiment;

FIG. 16 is a functional block diagram of a photoelectric conversion system according to the first application example;

FIGS. 17A and 17B are functional block diagrams of a photoelectric conversion system according to the second application example;

FIG. 18 is a functional block diagram of a photoelectric conversion system according to the third application example;

FIG. 19 is a functional block diagram of a photoelectric conversion system according to the fourth application example;

FIGS. 20A and 20B are functional block diagrams of a photoelectric conversion system according to the fifth application example;

FIGS. 21A and 21B are functional block diagrams of a photoelectric conversion system according to the sixth application example; and

FIG. 22 is a functional block diagram of a photoelectric conversion system according to the seventh application example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

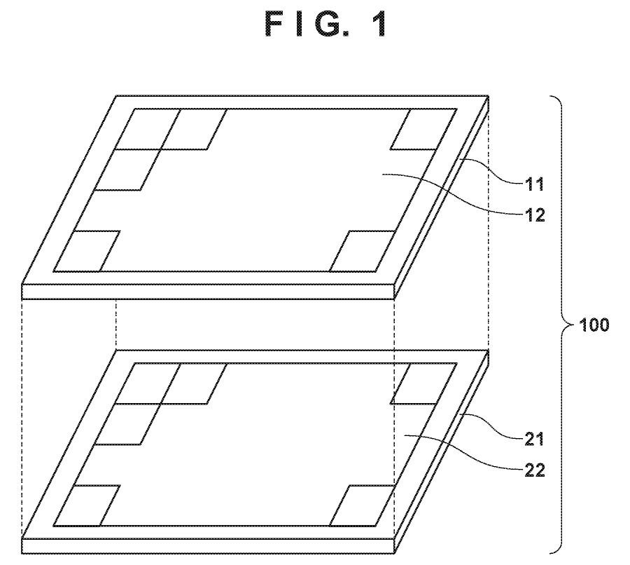

FIG. 1 schematically shows an example of the arrangement of a photoelectric conversion apparatus 100 according to an embodiment of the present disclosure. The photoelectric conversion apparatus 100 can have, for example, a structure in which a first substrate 11 and a second substrate 21 are stacked. The first substrate 11 can include, for example, an avalanche photodiode (to be referred to as APD hereinafter) array 12. The second substrate 21 can include a processing circuit 22 that processes signals output from the first substrate 11. The photoelectric conversion apparatus 100 may include one or more other substrates such as the third substrate, or may be constituted by one substrate.

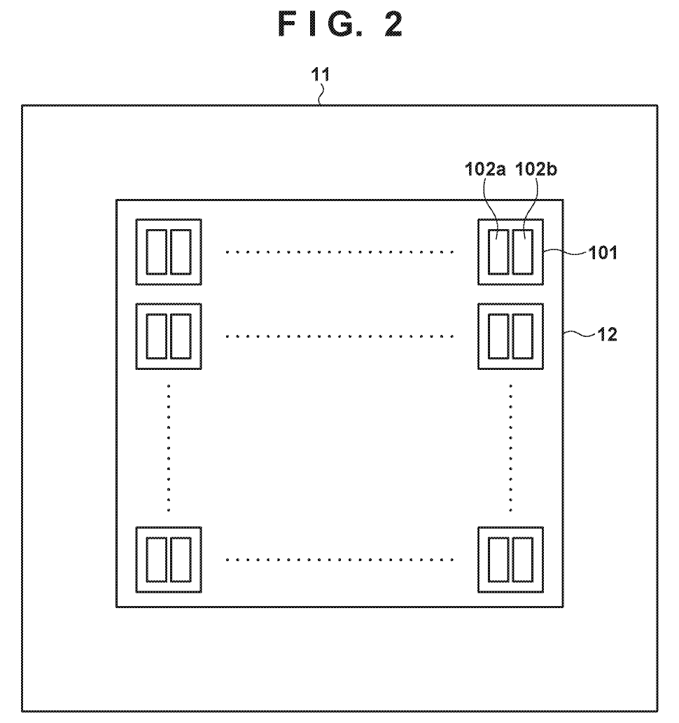

FIG. 2 schematically shows an example of the arrangement of the first substrate 11. The APD array 12 of the first substrate 11 can include a plurality of APD groups 101 arranged to form a plurality of rows and a plurality of columns. The APD group 101 includes at least two APDs 102a and 102b which can constitute a part of the APD group 101. The photoelectric conversion apparatus 100 will exemplarily be described below as an image capturing apparatus. However, the photoelectric conversion apparatus 100 may be formed as another apparatus. For example, the photoelectric conversion apparatus 100 can be formed as a distance measurement apparatus (for example, a focus detection apparatus or a distance measurement apparatus using TOF (Time Of Flight)) or a photometric apparatus (an apparatus for, for example, measuring an incident light amount). Note that a plurality of APD groups 101 may linearly be arranged. In this case, the photoelectric conversion apparatus 100 can form a line sensor.

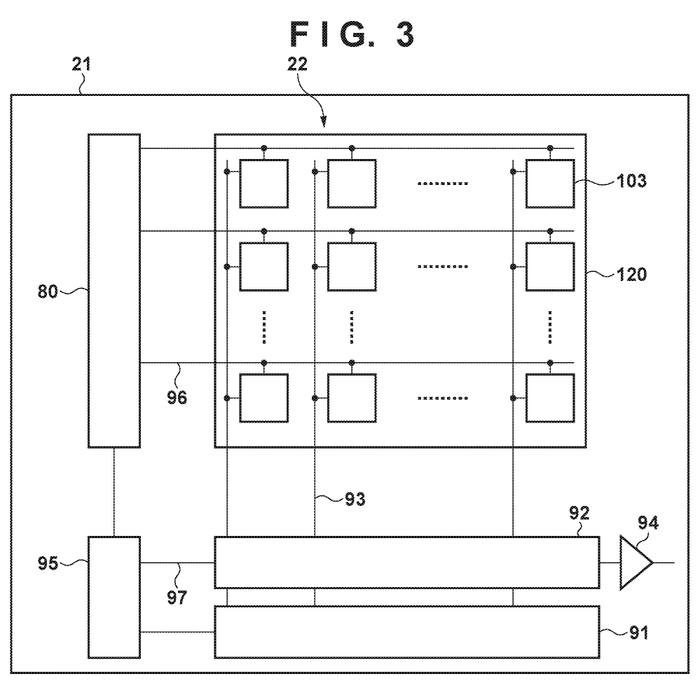

FIG. 3 schematically shows the arrangement of the processing circuit 22 of the second substrate 21. The processing circuit 22 can include, for example, a unit circuit array 120 including a plurality of unit circuits 103, a readout circuit 92, a control unit 95, a horizontal scanning circuit 91, a plurality of signal lines 93, a vertical scanning circuit 80, and an output unit 94. Each unit circuit 103 constitutes a pixel group together with the corresponding APD group 101, and processes a signal output from the APD group 101. The unit circuit 103 can include, for example, a counter and a memory. The memory can hold a count value obtained by counting by the counter. The APD array 12 and the unit circuit array 120 constitute a pixel array.

For example, the vertical scanning circuit 80 can sequentially select a plurality of rows of the unit circuit array 120 in accordance with a control signal supplied from the control unit 95. The vertical scanning circuit 80 can include, for example, at least one of a shift register and an address decoder. The readout circuit 92 reads out signals output, via the plurality of signal lines 93, from the unit circuits 103 of the row selected by the vertical scanning circuit 80. For example, the horizontal scanning circuit 91 supplies to the output unit 94, in a predetermined order, the signals for one row read out by the readout circuit 92.

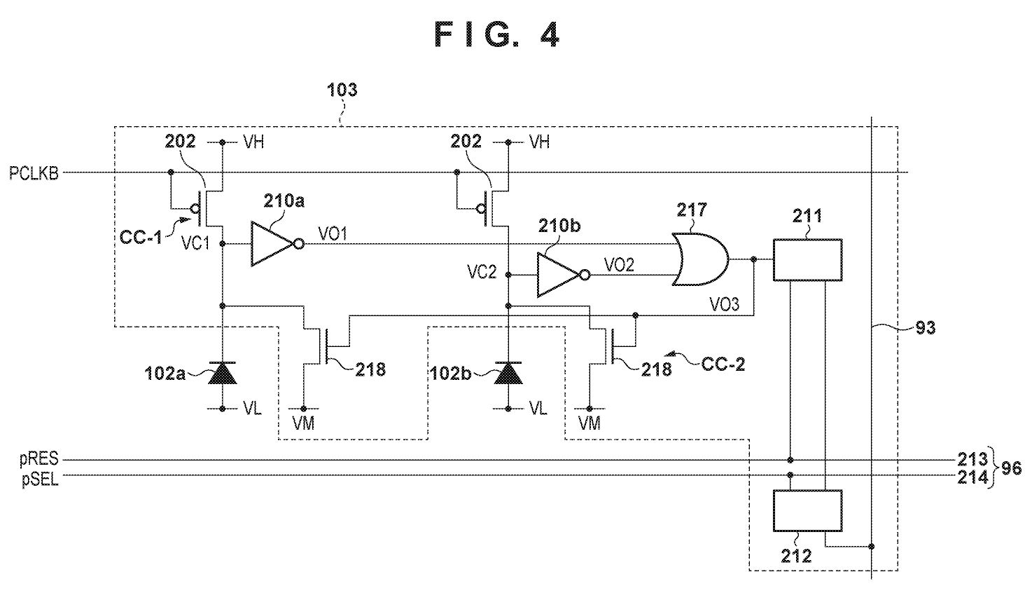

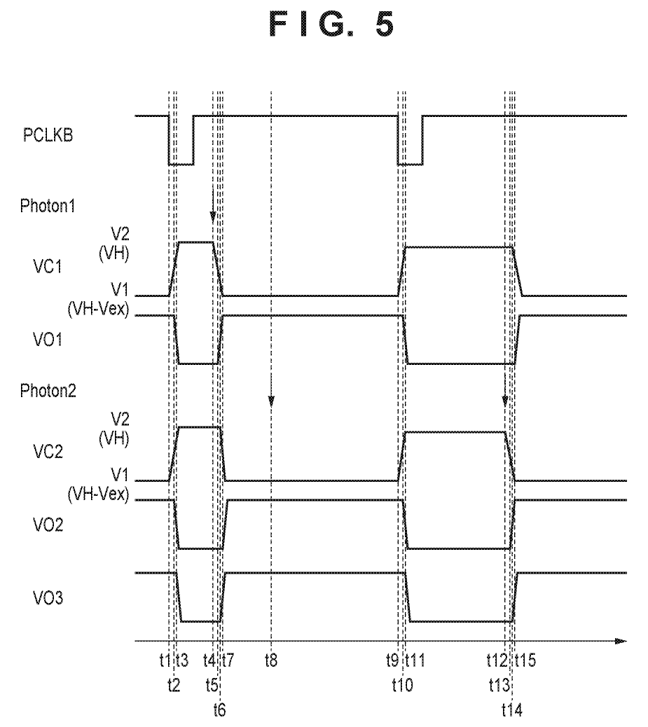

A photoelectric conversion apparatus 100 according to the first embodiment will be described with reference to FIGS. 4 and 5. FIG. 4 shows the arrangement of a unit circuit 103 of the photoelectric conversion apparatus 100 according to the first embodiment. The photoelectric conversion apparatus 100 or the unit circuit 103 can include a first APD 102a and a second APD 102b as a plurality of APDs. The photoelectric conversion apparatus 100 or the unit circuit 103 can also include a first control circuit CC-1 that sets each of the plurality of APDs 102a and 102b in a photon-detectable state in accordance with a first control signal PCLKB. The photoelectric conversion apparatus 100 or the unit circuit 103 can also include a plurality of shaping circuits 210a and 210b to which outputs of the plurality of APDs 102a and 102b are supplied, respectively. The plurality of shaping circuits 210a and 210b can generate detection signals VO1 and VO2 in accordance with the outputs of the plurality of APDs 102a and 102b, respectively. Generating the detection signals VO1 and VO2 means activating the detection signals VO1 and VO2. The photoelectric conversion apparatus 100 or the unit circuit 103 can also include a counter 211 that performs a count operation if the detection signal VO1 or VO2 is generated by the shaping circuit 210a or 210b. The photoelectric conversion apparatus 100 or the unit circuit 103 can also include a second control circuit CC-2 that sets the plurality of APDs 102a and 102b in an avalanche non-occurrence state if the detection signal VO1 or VO2 is generated by the shaping circuit 210a or 210b. Hereinafter, when expressing the APDs 102a and 102b without distinguishing them from each other, they are referred to as the APDs 102. Similarly, when expressing the shaping circuits 210a and 210b without distinguishing them from each other, they are referred to as the shaping circuits 210.

A first voltage VH can be applied to the cathode of the APD 102. A second voltage VL is applied to the anode of the APD 102, and the first voltage VH has a potential higher than the potential of the second voltage VL. A potential difference between the first voltage VH and the second voltage VL is applied to the APD 102 (between the anode and cathode of the APD 102). This potential difference is a reverse bias voltage that causes the APD to perform an avalanche multiplication operation. Charges generated by photons entering the APD 102 cause avalanche multiplication, thereby generating an avalanche current. A mode of applying a voltage higher than the breakdown voltage of the APD 102 between the anode and cathode of the APD 102 is called a Geiger mode. A mode of applying a voltage around or lower than the breakdown voltage between the anode and cathode of the APD 102 is called a linear mode. An APD operating in the Geiger mode is called an SPAD. In an example, the first voltage VH is 1 V, and the second voltage VL is -30 V.

The first control circuit CC-1 can include a switch 202 functioning as a quenching element. The switch 202 can be connected between a terminal supplied with the first voltage VH and the cathode of the APD 102. The switch 202 may be a transistor, and is a PMOS transistor in the example shown in FIG. 4. The switch 202 functioning as the quenching element has a function of converting the change of the avalanche current generated in the APD 102 into a voltage signal. The switch 202 functions as a load circuit (quenching circuit) at the time of signal multiplication by avalanche multiplication, and serves to suppress avalanche multiplication by suppressing the voltage applied to the APD 102. This is known as a quenching operation.

The shaping circuit 210 can output a pulse signal by shaping the potential change of the cathode of the APD 102 at the time of detection of a photon. The shaping circuit 210 can include, for example, an inverter circuit. In the example shown in FIG. 4, the shaping circuit 210 is formed by one inverter, but the shaping circuit 210 may be formed by series-connecting a plurality of inverters or by another circuit having the waveform shaping effect.

The counter 211 can be supplied with pulse signals output from the plurality of shaping circuits 210a and 210b via an OR circuit 217. The counter 211 can be configured to count the pulse signals output from the shaping circuits 210 via the OR circuit 217, and hold the count value obtained by counting. The counter 211 may be supplied with pulse signals output from the plurality of shaping circuits 210a and 210b without passing through the OR circuit 217. In this case, the counter 211 can be configured to perform a count operation if one of the pulse signals output from the plurality of shaping circuits 210a and 210b is activated, and hold the count value obtained by the count operation. If a first control pulse pRES of an active level is supplied from the vertical scanning circuit 80 via a driving line 213, the counter 211 can reset the count value.

In addition, the unit circuit 103 may include, for example, a selection circuit 212. If a second control pulse pSEL of an active level is supplied from the vertical scanning circuit 80 via a driving line 214, the selection circuit 212 can electrically connect the counter 211 and the signal line 93. The selection circuit 212 can include, for example, a buffer circuit.

The second control circuit CC-2 can be configured to control voltages VC1 and VC2 of the output terminals (cathodes) of the plurality of APDs 102a and 102b. The second control circuit CC-2 can include a plurality of transistors 218 that connect a line (VM line) applied with a predetermined voltage (third voltage VM) to the output terminals of the plurality of APDs 102a and 102b. The second control circuit CC-2 can further include the OR circuit 217 serving as a logic circuit that generates a second control signal VO3 by calculating a logical sum of outputs of the plurality of shaping circuits 210a and 210b. The OR circuit 217 can be understood as a circuit that activates the second control signal VO3 for setting the plurality of APDs 102a and 102b in an avalanche non-occurrence state if the detection signal VO1 or VO2 is generated by the shaping circuit 210a or 210b. The plurality of transistors 218 can be controlled by the OR circuit 217. The plurality of transistors 218 can be controlled by the second control signal VO3 output from the OR circuit 217. The plurality of transistors 218 are, for example, NMOS transistors.

FIG. 5 is a timing chart for explaining a photon detection operation in the photoelectric conversion apparatus 100 or the unit circuit 103 according to the first embodiment. In this example, the first control signal PCLKB is a low-active signal, and can be periodically activated at low level. At time t1, the first control signal PCLKB is activated at low level. This activates the switches 202, and the voltages VC1 and VC2 of the output terminals (cathodes) of the APDs 102a and 102b transition to V2 (= VH). With this, the outputs VO1 and VO2 of the shaping circuits 210a and 210b are inverted, and the second control signal VO3, which is the output signal of the OR circuit 217, is deactivated at low level. In this state, the plurality of APDs 102a and 102b can detect photons.

In the example shown in FIG. 5, subsequently, at arbitrary time t4, a photon (photon 1) enters the first APD 102a. With this, the voltage VC1 of the output terminal (cathode) of the first APD 102a drops to V1 (= VH - Vex), and the output VO1 of the shaping circuit 210a is inverted (Vex indicates the voltage drop in the APD 102 at the time of avalanche multiplication). In addition, the second control signal VO3, which is the output signal of the OR circuit 217, is activated at high level. With this, the voltage VC2 of the output terminal (cathode) of the second APD 102b drops to VM (= VH - Vex). In this state, avalanche multiplication does not occur in the plurality of APDs 102a and 102b.

At time t9, the first control signal PCLKB is activated again at low level. This activates the switches 202, and the voltages VC1 and VC2 of the output terminals (cathodes) of the APDs 102a and 102b transition to V2 (= VH). With this, the outputs VO1 and VO2 of the shaping circuits 210a and 210b are inverted, and the second control signal VO3, which is the output signal of the OR circuit 217, is deactivated at low level. In this state, the plurality of APDs 102a and 102b can detect photons.

In the example shown in FIG. 5, subsequently, at arbitrary time t12, a photon (photon 2) enters the second APD 102b. With this, the voltage VC2 of the output terminal (cathode) of the second APD 102b drops to V1 (= VH - Vex), and the output VO2 of the shaping circuit 210b is inverted. In addition, the second control signal VO3, which is the output signal of the OR circuit 217, is activated at high level. With this, the voltage VC1 of the output terminal (cathode) of the first APD 102a drops to VM (= VH - Vex). In this state, avalanche multiplication does not occur in the plurality of APDs 102a and 102b.

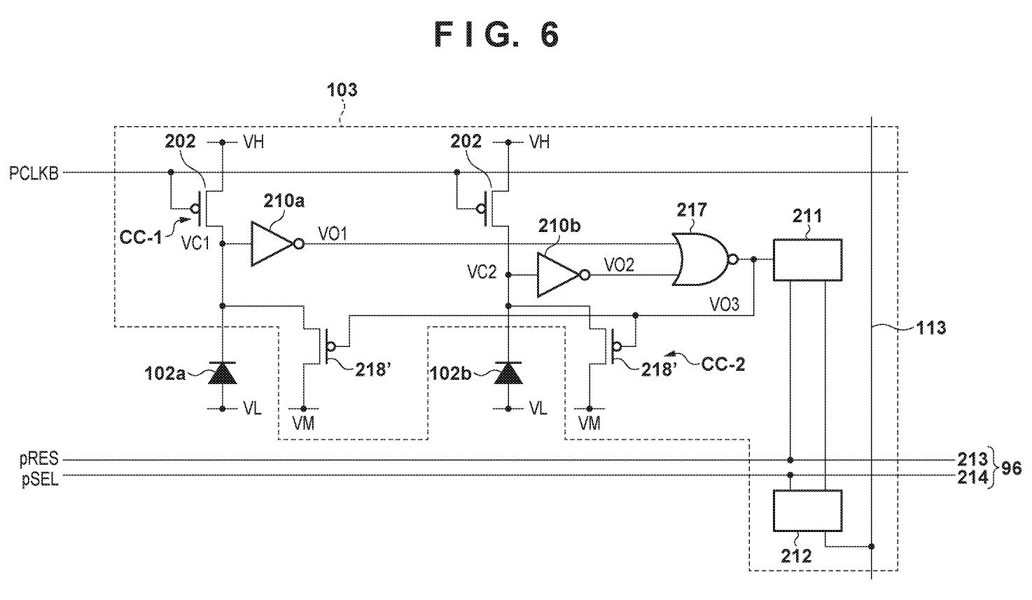

A photoelectric conversion apparatus 100 according to the second embodiment will be described below with reference to FIG. 6. Matters not mentioned in the second embodiment can follow the first embodiment. FIG. 6 shows the arrangement of a unit circuit 103 of the photoelectric conversion apparatus 100 according to the second embodiment. In the second embodiment, the OR circuit 217 in the first embodiment is changed to a NOR circuit 220, and the transistor 218 (NMOS transistor) in the first embodiment is changed to a transistor 218' (PMOS transistor). As the transistor 218' (PMOS transistor), for example, a depletion-type transistor with a low threshold can be used. In an example, a switch 202 and the transistor 218' can be formed by PMOS transistors and arranged in the same well.

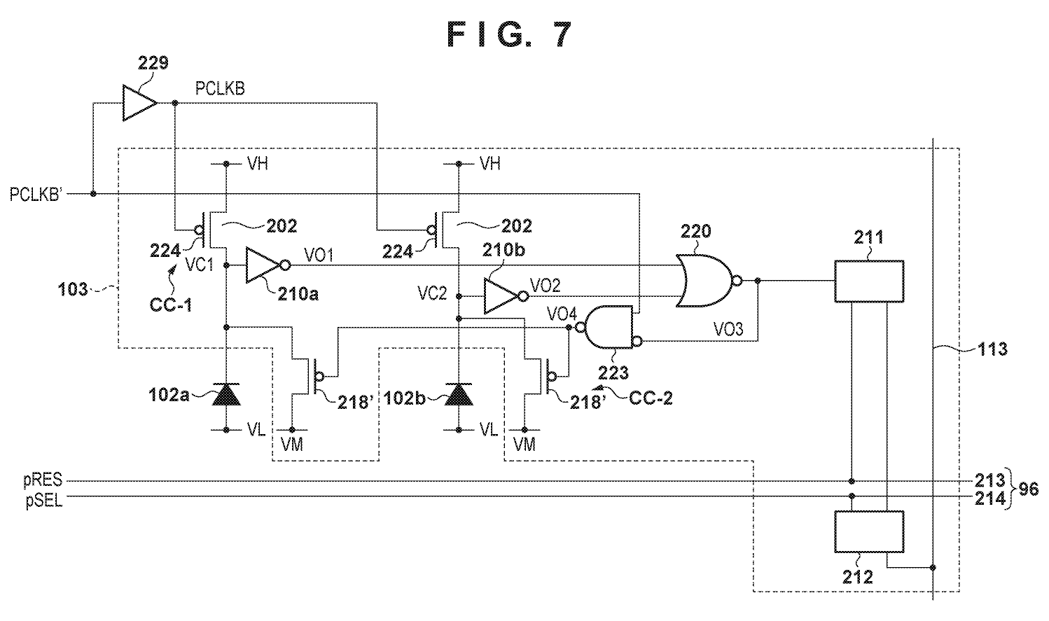

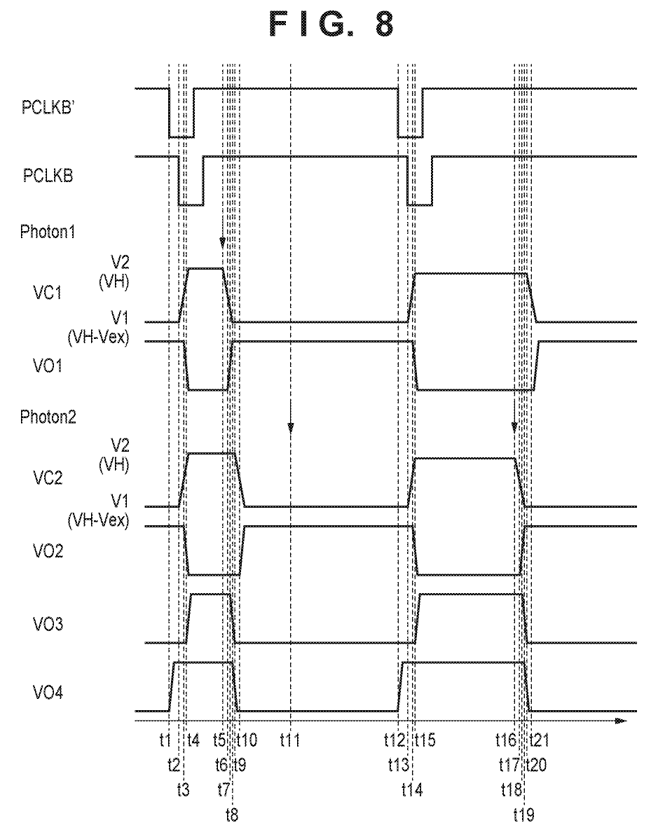

A photoelectric conversion apparatus 100 according to the third embodiment will be described below with reference to FIGS. 7 and 8. Matters not mentioned in the third embodiment can follow the first or second embodiment. FIG. 7 shows the arrangement of a unit circuit 103 of the photoelectric conversion apparatus 100 according to the third embodiment. The photoelectric conversion apparatus 100 or the unit circuit 103 according to the third embodiment can include a deactivation circuit 223 that deactivates a second control circuit CC-2 in accordance with a deactivation signal PCLKB'. A first control signal PCLKB is, for example, a signal that transitions with a delay relative to the transition of the deactivation signal PCLKB'. The photoelectric conversion apparatus 100 or the unit circuit 103 according to the third embodiment can include a delay circuit 229 that generates, as a control signal, a delay signal with a delay relative to the deactivation signal PCLKB'. In the third embodiment, a first control circuit CC-1 can be activated in a state in which the second control circuit CC-2 is deactivated, that is, a transistor 218' is turned off. This prevents flowing of a through current caused by simultaneously turning on a switch 202 and the transistor 218'.

FIG. 8 is a timing chart for explaining a photon detection operation in the photoelectric conversion apparatus 100 or the unit circuit 103 according to the third embodiment. As shown in FIG. 8, in the third embodiment, if the first control signal PCLKB is activated in the state in which a detection signal VO4 is deactivated at high level to deactivate the second control circuit CC-2, the switch 202 is turned on.

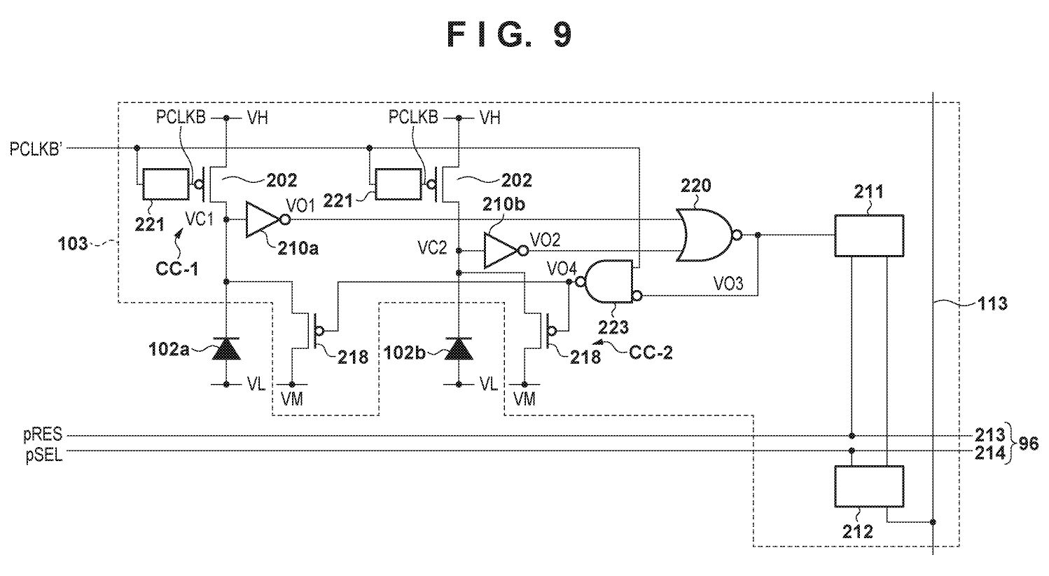

FIG. 9 shows the photoelectric conversion apparatus 100 according to a modification of the third embodiment. In this modification, a delay circuit 221 that generates a delay signal of the deactivation signal PCLKB' as the first control signal PCLKB is provided for each switch 202.

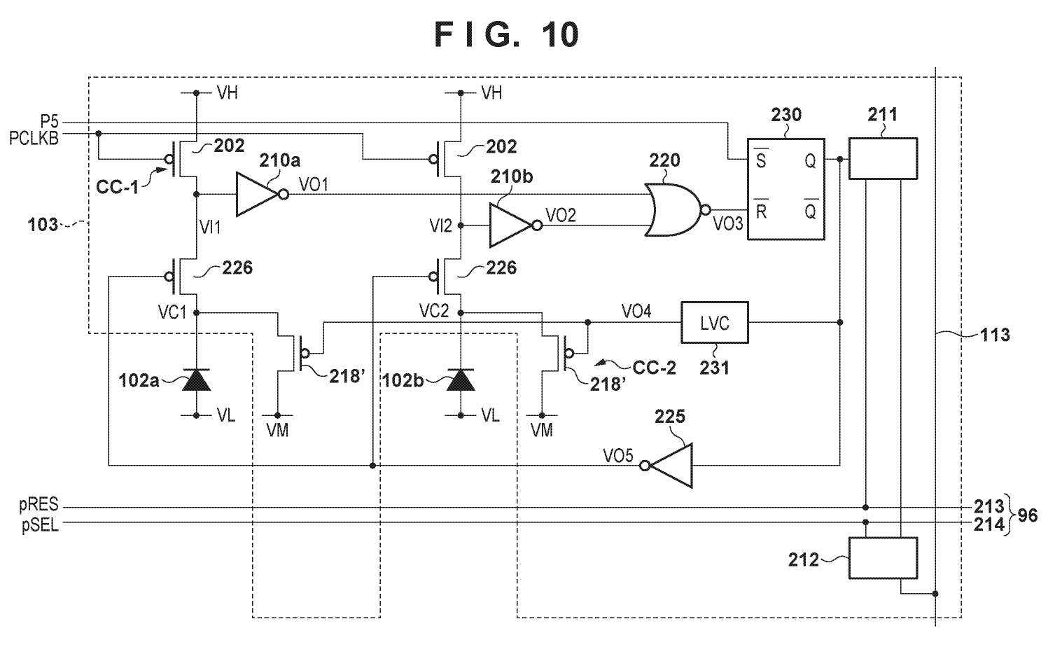

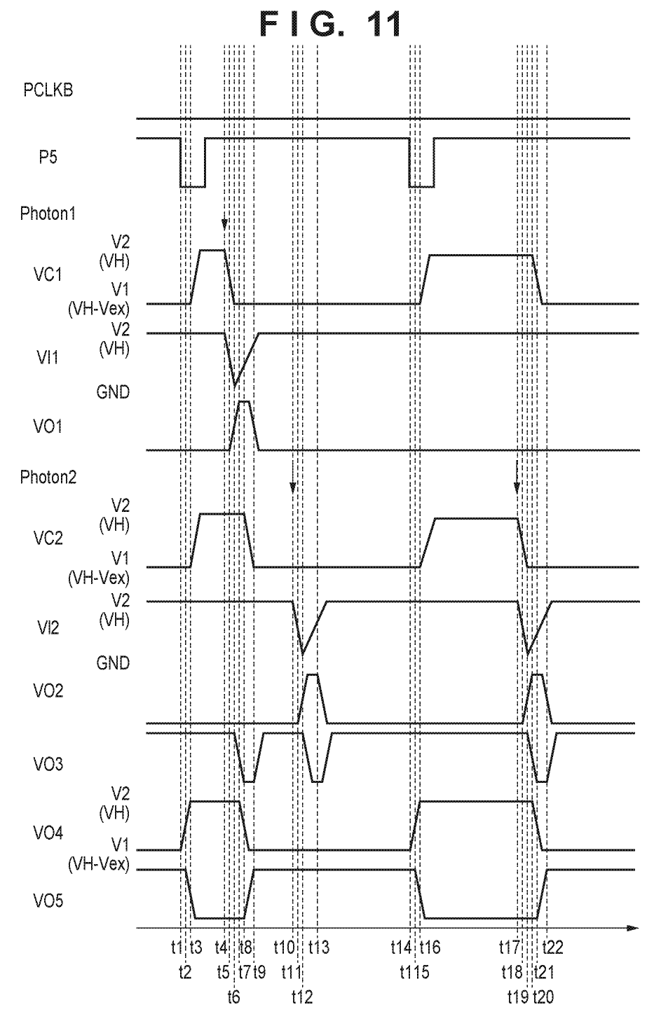

A photoelectric conversion apparatus 100 according to the fourth embodiment will be described below with reference to FIGS. 10 and 11. Matters not mentioned in the fourth embodiment can follow the first to third embodiments. FIG. 10 shows the arrangement of a unit circuit 103 of the photoelectric conversion apparatus 100 according to the fourth embodiment. FIG. 11 is a timing chart for explaining a photon detection operation in the photoelectric conversion apparatus 100 or the unit circuit 103 according to the fourth embodiment.

The photoelectric conversion apparatus 100 or the unit circuit 103 according to the fourth embodiment can include a plurality of level shifters 226 connected in series to a plurality of APDs 102a and 102b, respectively. The plurality of level shifters 226 can be deactivated if a second control circuit CC-2 (transistors 218') is activated, and can be activated if the second control circuit CC-2 is deactivated. Each of the plurality of level shifters 226 can be a transistor, for example, a PMOS transistor. This PMOS transistor can be a depletion-type transistor. The plurality of level shifters 226 can be arranged between a first control circuit CC-1 (switches 202) and the APDs 102.

The second control circuit CC-2 can include a NOR circuit 220 and a latch circuit 230. The NOR circuit 220 calculates a logical sum of outputs of a plurality of shaping circuits 210a and 210b. An output of the NOR circuit 220 and a control signal P5 are input to the latch circuit 230. The control signal P5 is a low-active signal, and can be periodically activated at low level. If the output of the NOR circuit 220 is activated, the latch circuit 230 activates the second control circuit CC-2 to deactivate the plurality of level shifters 226. When starting photon detection, the latch circuit 230 can operate to activate the plurality of level shifters 226. The latch circuit 230 can include, for example, an SR latch circuit. An output of the latch circuit 230 can be provided to the plurality of transistors 218' via a voltage level conversion circuit 231. By providing the voltage level conversion circuit 231, it is possible to change the voltage amplitude in accordance with the potential of VM when outputting the input detection signal. Accordingly, the ON/OFF control of the plurality of transistors 218' can be reliably performed.

As shown in FIG. 11, in the fourth embodiment, if the control signal P5 is at low level and a detection signal VO3 is at high level, the second control circuit CC-2 is deactivated and the level shifters 226 are activated. If the control signal P5 is at high level and the detection signal VO3 is at low level, the second control circuit CC-2 is activated and the level shifters 226 are deactivated.

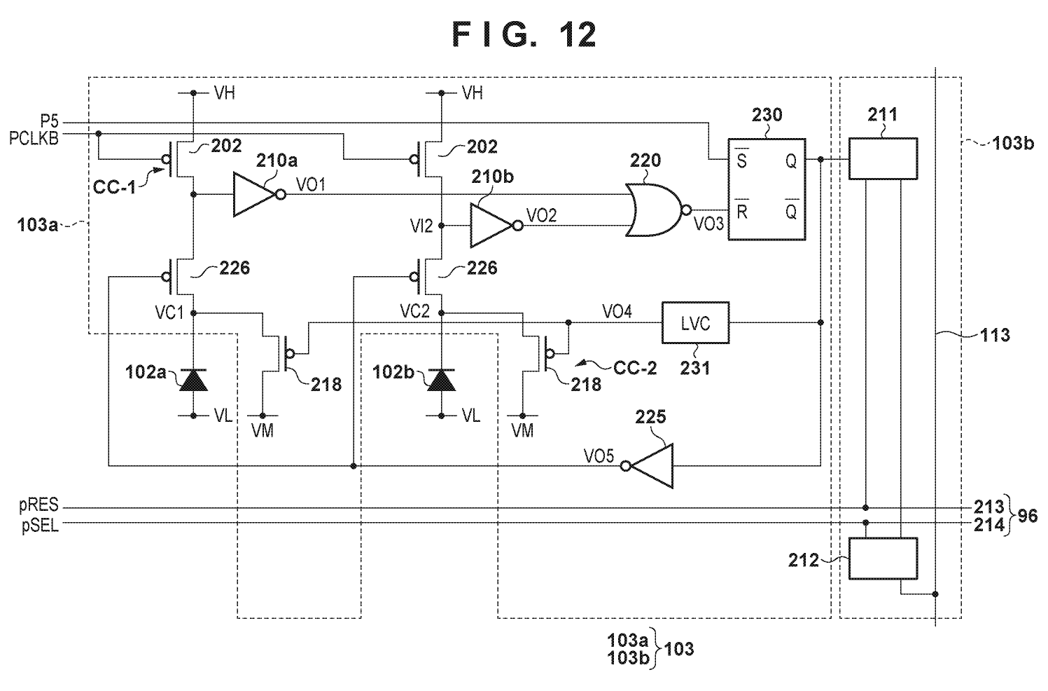

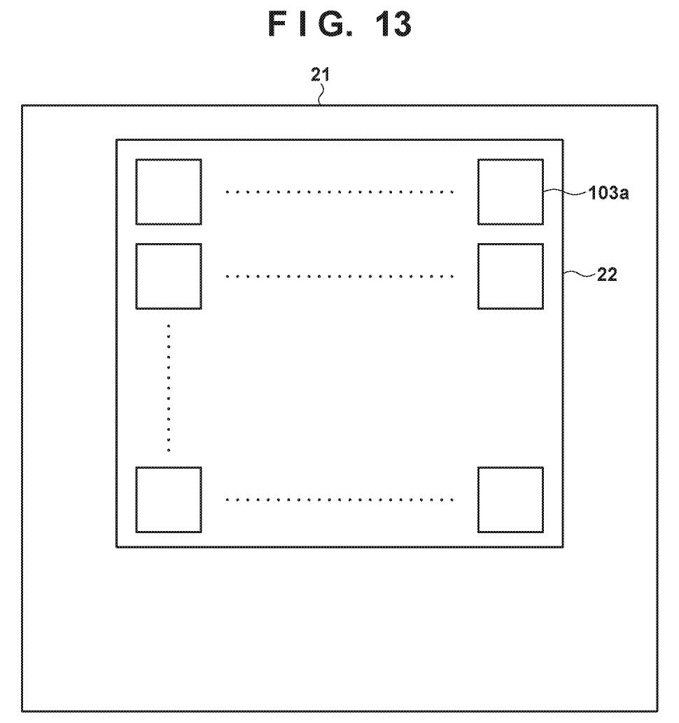

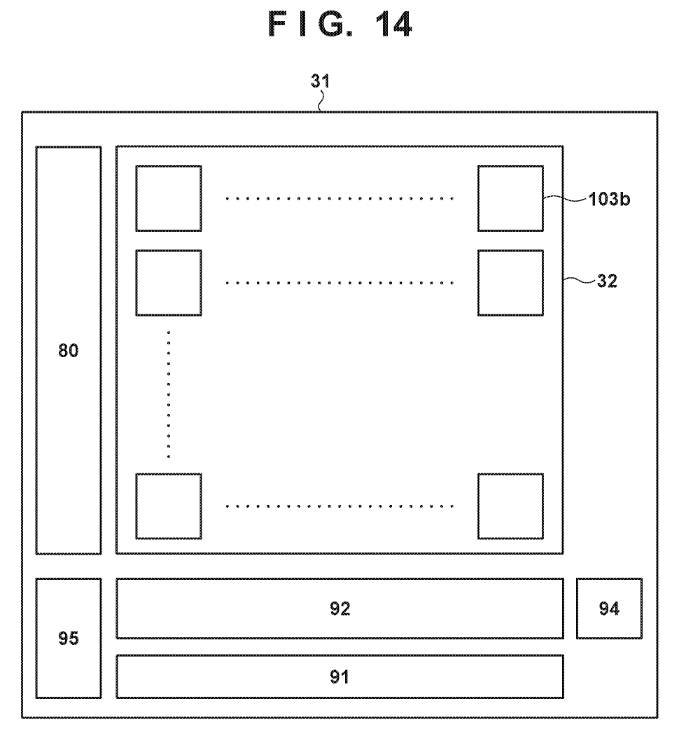

A photoelectric conversion apparatus 100 according to the fifth embodiment will be described below with reference to FIGS. 2 and 12 to 14. Matters not mentioned as the fifth embodiment can follow the fourth embodiment. FIG. 12 shows the arrangement of a unit circuit 103 of the photoelectric conversion apparatus 100 according to the fifth embodiment. In this embodiment, FIG. 2 is cited to schematically show the arrangement of a first substrate 11 constituting the photoelectric conversion apparatus 100. FIG. 13 schematically shows the arrangement of a second substrate 21 constituting the photoelectric conversion apparatus 100. FIG. 14 schematically shows the arrangement of a third substrate 31 constituting the photoelectric conversion apparatus 100.

In the fifth embodiment, the photoelectric conversion apparatus 100 can be formed by a stack of the first substrate 11, the second substrate 21, and the third substrate 31. The unit circuit 103 in the fourth embodiment is divided into a first unit circuit 103a and a second unit circuit 103b. In an example, out of components of the unit circuit 103, a counter 211 and a selection circuit 212 can be arranged as the second unit circuit 103b in the third substrate 31, and the remaining components of the unit circuit 103 can be arranged as the first unit circuit 103a in the second substrate 21. In the example shown in FIG. 14, a vertical scanning circuit 80, a horizontal scanning circuit 91, a readout circuit 92, an output unit 94, and a control unit 95 are arranged in the third substrate 31.

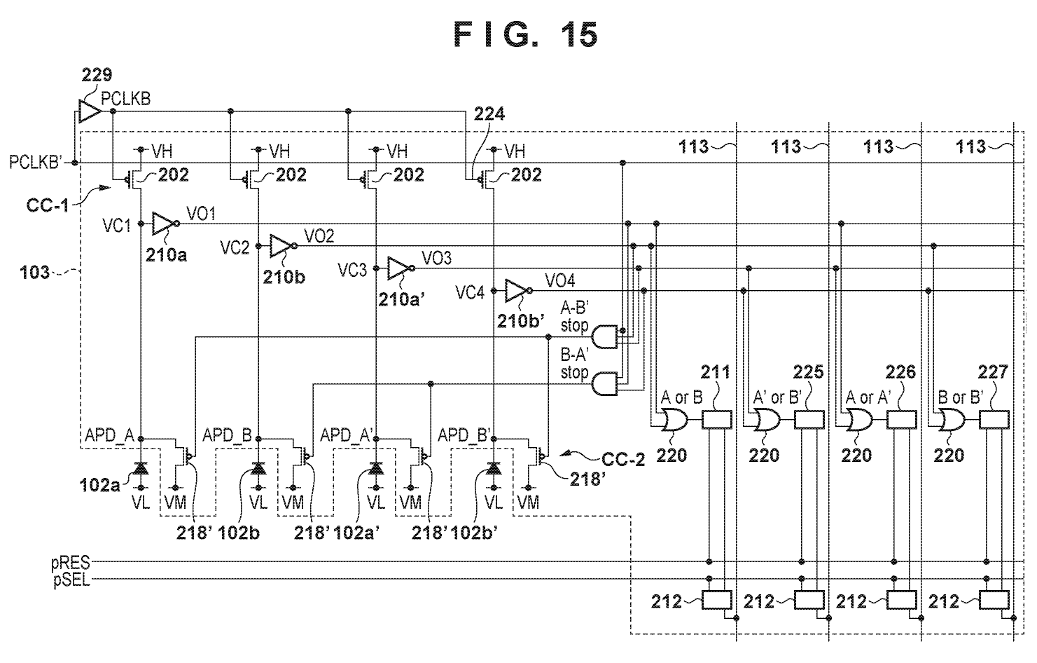

A photoelectric conversion apparatus 100 according to the sixth embodiment will be described below with reference to FIG. 15. Matters not mentioned as the sixth embodiment can follow the first to fifth embodiments. FIG. 12 shows the arrangement of a unit circuit 103 of the photoelectric conversion apparatus 100 according to the sixth embodiment.

In the sixth embodiment, the photoelectric conversion apparatus 100 or the unit circuit 103 can include first to fourth APDs 102a, 102b, 102a', and 102b' as a plurality of APDs. A first control circuit CC-1 can be provided that is configured to set the first to fourth APDs 102a, 102b, 102a', and 102b' in a photon-detectable state in accordance with a first control signal PCLKB. The photoelectric conversion apparatus 100 can include first to fourth shaping circuits 210a, 210b, 210a', and 210b' that generate first to fourth detection signals VO1, VO2, VO3, and VO4 in accordance with outputs of the first to fourth APDs 102a, 102b, 102a', and 102b', respectively.

The photoelectric conversion apparatus 100 or the unit circuit 103 can also include a first counter 211, a second counter 225, a third counter 226, and a fourth counter 227. The first counter 211 performs a count operation if the detection signal VO1 is generated by the first shaping circuit 210a and the detection signal VO2 is generated by the second shaping circuit 210b. The second counter 225 performs a count operation if the detection signal VO3 is generated by the third shaping circuit 210a' and the detection signal VO4 is generated by the fourth shaping circuit 210b'. The third counter 226 performs a count operation if the detection signal VO1 is generated by the first shaping circuit 210a and the detection signal VO3 is generated by the third shaping circuit 210a'. The fourth counter 227 performs a count operation if the detection signal VO2 is generated by the second shaping circuit 210b and the detection signal VO4 is generated by the fourth shaping circuit 210b'.

The photoelectric conversion apparatus 100 or the unit circuit 103 can also include a second control circuit CC-2. If the detection signal VO1 is generated by the first shaping circuit 210a and the detection signal VO4 is generated by the fourth shaping circuit 210b', the second control circuit CC-2 sets the second APD 102b and the third APD 102a' in an avalanche non-occurrence state. If the detection signal VO2 is generated by the second shaping circuit 210b and the detection signal VO3 is generated by the third shaping circuit 210a', the second control circuit CC-2 sets the first APD 102a and the fourth APD 102b' in an avalanche non-occurrence state.

The first APD 102a and the second APD 102b can form a pair for phase difference detection, and the third APD 102a' and the fourth APD 102b' can form a pair for phase difference detection. The second control circuit CC-2 can be configured to control voltages of output terminals VC1, VC2, VC3, and VC4 of the first to fourth APDs 102a, 102b, 102a', and 102b', respectively. The second control circuit CC-2 can include a plurality of transistors 218' that connect a line applied with a predetermined voltage (VM) to the output terminals VC1, VC2, VC3, and VC4 of the first to fourth APDs 102a, 102b, 102a', and 102b'.

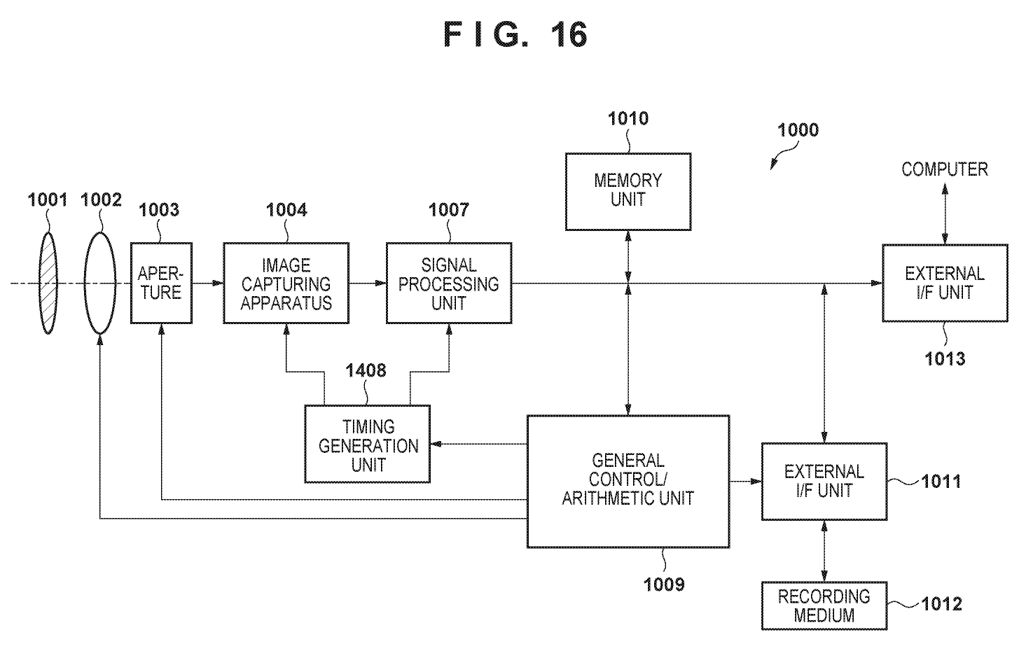

With reference to FIG. 16, a photoelectric conversion system according to the first application example will be described below. FIG. 16 is a block diagram showing the schematic configuration of a photoelectric conversion system according to the first application example.

The above-described photoelectric conversion apparatus 100 is applicable to various kinds of photoelectric conversion systems. Examples of photoelectric conversion systems to which the photoelectric conversion apparatus is applicable are a digital still camera, a digital camcorder, a monitoring camera, a copying machine, a facsimile apparatus, a mobile phone, an in-vehicle camera, and an observation satellite. A camera module including an optical system such as a lens and an image capturing apparatus is also included in the photoelectric conversion systems. FIG. 16 exemplarily shows the block diagram of a digital still camera as an example of these.

A photoelectric conversion system 1000 exemplarily shown in FIG. 16 includes an image capturing apparatus 1004 as an example of the photoelectric conversion apparatus. The photoelectric conversion system 1000 also includes a lens 1002 that forms an optical image of an object on the image capturing apparatus 1004, an aperture 1003 configured to change the amount of light passing through the lens 1002, and a barrier 1001 configured to protect the lens 1002. The lens 1002 and the aperture 1003 form an optical system (optical apparatus) that condenses light to the image capturing apparatus 1004. The image capturing apparatus 1004 is the photoelectric conversion apparatus 100 (image capturing apparatus) according to one of the above-described embodiments, and converts the optical image formed by the lens 1002 into an electrical signal.

The photoelectric conversion system 1000 also includes a signal processing unit 1007 that is an image generation unit configured to generate an image by processing an output signal output from the image capturing apparatus 1004. The signal processing unit 1007 functions as a processing apparatus that performs an operation of performing various kinds of correction and compression as needed, thereby outputting image data. The signal processing unit 1007 may be formed on a semiconductor substrate on which the image capturing apparatus 1004 is provided or may be formed on a semiconductor substrate different from that of the image capturing apparatus 1004. In addition, the image capturing apparatus 1004 and the signal processing unit 1007 may be formed on the same semiconductor substrate.

The photoelectric conversion system 1000 further includes a memory unit 1010 configured to temporarily store image data, and an external interface unit (external I/F unit) 1013 configured to communicate with an external computer or the like. Furthermore, the photoelectric conversion system 1000 includes a recording medium 1012 such as a semiconductor memory configured to record or read out image capturing data, and a recording medium control I/F unit 1011 configured to perform record or readout for the recording medium 1012. The recording medium control I/F unit 1011 and the recording medium 1012 can form a part of a recording apparatus. Note that the recording medium 1012 may be incorporated in the photoelectric conversion system 1000 or may be detachable.

Furthermore, the photoelectric conversion system 1000 includes a general control/arithmetic unit 1009 that controls various kinds of operations and the entire digital still camera, and a timing generation unit 1408 that outputs various kinds of timing signals to the image capturing apparatus 1004 and the signal processing unit 1007. The general control/arithmetic unit 1009 and the timing generation unit 1408 can form a part of a control apparatus configured to control an operation of the photoelectric conversion system 1000. In this example, the timing signal and the like may be input from the outside, and the photoelectric conversion system 1000 need only include at least the image capturing apparatus 1004, and the signal processing unit 1007 that processes an output signal output from the image capturing apparatus 1004.

The image capturing apparatus 1004 outputs an image capturing signal to the signal processing unit 1007. The signal processing unit 1007 executes predetermined signal processing for the image capturing signal output from the image capturing apparatus 1004, and outputs image data. The signal processing unit 1007 generates an image using the image capturing signal. Although not shown in FIG. 16, a display apparatus such as a display for displaying the generated image may be arranged in the photoelectric conversion system 1000. As described above, according to this application example, it is possible to implement the photoelectric conversion system 1000 to which the photoelectric conversion apparatus 100 (image capturing apparatus) according to one of the above-described embodiments is applied.

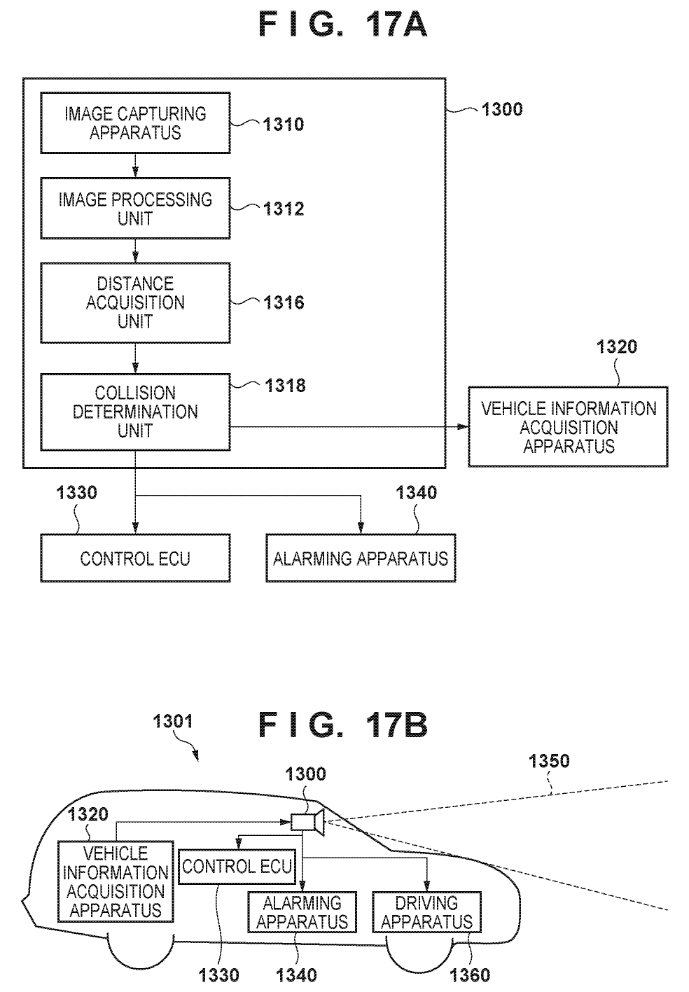

A photoelectric conversion system 1300 and a moving body 1301 according to the second application example will be described with reference to FIGS. 17A and 17B. FIGS. 17A and 17B are views showing the arrangement of the photoelectric conversion system 1300 and the moving body 1301 according to the second application example.

FIG. 17A shows an example of a photoelectric conversion system concerning an in-vehicle camera. The photoelectric conversion system 1300 includes an image capturing apparatus 1310. The image capturing apparatus 1310 is the photoelectric conversion apparatus 100 (image capturing apparatus) described in one of the above-described embodiments. The photoelectric conversion system 1300 includes an image processing unit 1312 that performs image processing for a plurality of image data acquired by the image capturing apparatus 1310. The photoelectric conversion system 1300 also includes a distance acquisition unit 1316 that calculates the distance up to a target object, and a collision determination unit 1318 that determines, based on the calculated distance, whether there is collision possibility. Here, the distance acquisition unit 1316 may acquire distance information up to a target object by using Time of Flight (ToF) method, or may acquire distance information by using parallax information or the like. That is, the distance information is information concerning parallax, a defocus amount, a distance up to a target object, and the like. The collision determination unit 1318 may determine collision possibility using one of the pieces of distance information. The distance acquisition unit 1316 may be implemented by exclusively designed hardware, or may be implemented by a software module. The distance acquisition unit 1316 may be implemented by a Field Programmable Gate Array (FPGA), Application Specific Integrated Circuit (ASIC), or the like. Alternatively, the distance acquisition unit 1316 may be implemented by a combination of these.

The photoelectric conversion system 1300 is connected to a vehicle information acquisition apparatus 1320, and can acquire vehicle information such as a vehicle speed, a yaw rate, and a steering angle. The photoelectric conversion system 1300 is also connected to an ECU 1330 that is a control apparatus configured to output a control signal for generating a braking force to the vehicle based on the determination result of the collision determination unit 1318. Furthermore, the photoelectric conversion system 1300 is connected to an alarm apparatus 1340 that generates an alarm to the driver based on the determination result of the collision determination unit 1318. For example, if collision possibility is high as the determination result of the collision determination unit 1318, the ECU 1330 controls a driving apparatus (machine apparatus) 1360 to perform braking, releasing the accelerator pedal, or suppressing the engine output, thereby controlling the vehicle for avoiding collision and reducing damage. The alarm apparatus 1340 sounds an alarm, displays alarm information on the screen of a car navigation system or the like, or applies a vibration to the seat belt or a steering wheel, thereby making an alarm to the user.

In this application example, the periphery of the vehicle (moving body 1301), for example, the front or rear side is captured by the photoelectric conversion system 1300. FIG. 17B shows the photoelectric conversion system when capturing the front side (image capturing range 1350) of the vehicle. The vehicle information acquisition apparatus 1320 sends an instruction to the photoelectric conversion system 1300 or the image capturing apparatus 1310. With this configuration, it is possible to further improve the accuracy of distance measurement.

An example in which control is executed so as not to collide with another vehicle has been explained above. The photoelectric conversion system 1300 can also be applied to control of performing automated driving following another vehicle or control of performing automated driving without deviating from a lane. Furthermore, the photoelectric conversion system 1300 can be applied not only to a vehicle such as an automobile but also to, for example, a moving body (moving apparatus) such as a ship, an airplane, or an industrial robot. The moving body includes one or both of a driving force generation unit that generates a driving force mainly used for moving the moving body and a rotating body mainly used for moving the moving body. The driving force generation unit can be an engine, a motor, or the like. The rotating body can be a tire, a wheel, a ship screw, a propeller of a moving body, or the like. In addition, the photoelectric conversion system can be applied not only to a moving body but also to equipment that broadly uses object recognition, such as an intelligent transport system (ITS).

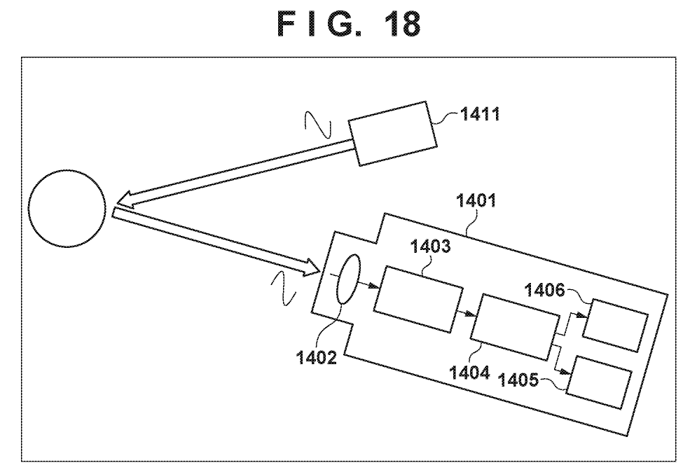

A photoelectric conversion system according to the third application example will be described with reference to FIG. 18. FIG. 18 is a block diagram showing an example of the arrangement of a distance image sensor 1401 as the photoelectric conversion system according to this embodiment.

As shown in FIG. 18, the distance image sensor 1401 includes an optical system 1402, a photoelectric conversion apparatus 1403, an image processing circuit 1404, a monitor 1405, and a memory 1406. Then, the distance image sensor 1401 can receive light (modulated light or pulsed light) projected from a light source apparatus 1411 toward an object and reflected by the surface of the object, thereby acquiring a distance image corresponding to the distance up to the object.

The optical system 1402 is formed by including one or a plurality of lenses, and guides image light (incident light) from the object to the photoelectric conversion apparatus 1403 and forms an image on the light-receiving surface (sensor portion) of the photoelectric conversion apparatus 1403.

As the photoelectric conversion apparatus 1403, the photoelectric conversion apparatus 100 of each of the above-described embodiments is applied, and a distance signal indicating a distance obtained from a light reception signal output from the photoelectric conversion apparatus 1403 is supplied to the image processing circuit 1404.

The image processing circuit 1404 performs image processing of creating a distance image based on the distance signal supplied from the photoelectric conversion apparatus 1403. Then, the distance image (image data) obtained by the image processing is supplied to and displayed on the monitor 1405, and supplied to and stored (recorded) in the memory 1406.

The distance image sensor 1401 having such arrangement can acquire, for example, a more correct distance image along with improvement in characteristic of pixels by applying the above-described photoelectric conversion apparatus 100.

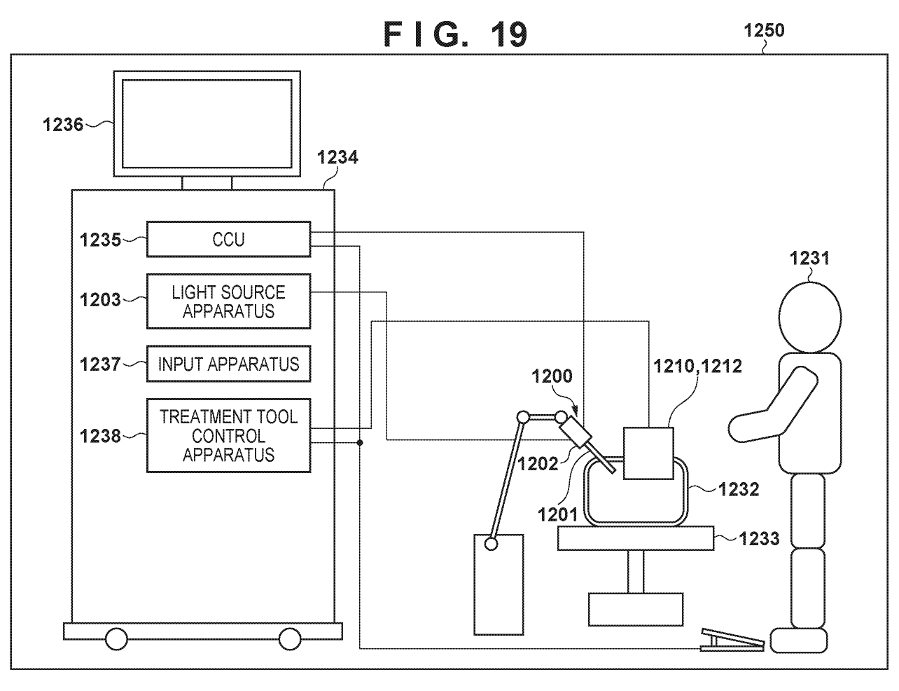

A photoelectric conversion system according to the fourth application example will be described with reference to FIG. 19. FIG. 19 is a view showing an example of the schematic arrangement of an endoscopic surgery system 1250 as the photoelectric conversion system according to the fourth application example.

FIG. 19 shows a state in which an operator (doctor) 1231 operates on a patient 1232 on a patient bed 1233 using the endoscopic surgery system 1250. As shown in FIG. 19, the endoscopic surgery system 1250 is formed from an endoscope 1200, a surgical tool 1210, and a cart 1234 on which various apparatuses for endoscopic surgery are mounted.

The endoscope 1200 includes a lens barrel 1201 including a region of a predetermined length from the distal end, which is inserted into the body cavity of the patient 1232, and a camera head 1202 connected to the proximal end of the lens barrel 1201. In the example shown in FIG. 19, the endoscope 1200 formed as a so-called hard mirror including the hard lens barrel 1201 is shown but the endoscope 1200 may be formed as a so-called soft mirror including a soft lens barrel.

An opening in which an objective lens is fitted is provided at the distal end of the lens barrel 1201. A light source apparatus 1203 is connected to the endoscope 1200, and light generated by the light source apparatus 1203 is guided to the distal end of the lens barrel by a light guide extended inside the lens barrel 1201, and is emitted to an observation target in the body cavity of the patient 1232 via the objective lens. Note that the endoscope 1200 may be a forward-viewing endoscope or may be a forward-oblique viewing endoscope or side-viewing endoscope.

An optical system and a photoelectric conversion apparatus are provided in the camera head 1202, and reflected light (observation light) from the observation target is condensed by the optical system to the photoelectric conversion apparatus. The observation light is photoelectrically converted by the photoelectric conversion apparatus to generate an electrical signal corresponding to the observation light, that is, an image signal corresponding to an observation image. As the photoelectric conversion apparatus, the photoelectric conversion apparatus 100 (image capturing apparatus) described in each of the above-described embodiments can be used. The image signal is transmitted as RAW data to a Camera Control Unit (CCU) 1235.

The CCU 1235 is formed by a Central Processing Unit (CPU), a Graphics Processing Unit (GPU), and the like, and comprehensively controls the operations of the endoscope 1200 and a display apparatus 1236. Furthermore, the CCU 1235 receives an image signal from the camera head 1202, and performs, for the image signal, various kinds of image processes such as development processing (demosaic processing) for displaying an image based on the image signal.

Under the control of the CCU 1235, the display apparatus 1236 displays the image based on the image signal having undergone the image processing by the CCU 1235.

The light source apparatus 1203 is formed from a light source such as a Light Emitting Diode (LED), and supplies, to the endoscope 1200, irradiation light at the time of imaging an operation site or the like.

An input apparatus 1237 is an input interface to the endoscopic surgery system 1250. The user can input various kinds of information or instructions to the endoscopic surgery system 1250 via the input apparatus 1237.

A treatment tool control apparatus 1238 controls driving of an energy treatment tool 1212 for ablation or incision of the tissue, sealing of a blood vessel, or the like.

The light source apparatus 1203 that supplies, to the endoscope 1200, irradiation light at the time of imaging an operation site can be formed from, for example, a white light source formed by an LED, a laser light source, or a combination thereof. If the white light source is formed by a combination of RGB laser light sources, it is possible to accurately control the output intensity and output timing of each color (each wavelength), and thus the light source apparatus 1203 can adjust the white balance of a captured image. In this case, the observation target is time-divisionally irradiated with laser beams from the RGB laser light sources, respectively, and driving of the image sensor of the camera head 1202 is controlled in synchronism with the irradiation timings, thereby making it possible to time-divisionally capture images respectively corresponding to R, G, and B. In this method, it is possible to obtain a color image without providing color filters in the image sensor.

Driving of the light source apparatus 1203 may be controlled to change the intensity of light to be output for every predetermined time. It is possible to time-divisionally acquire images by controlling driving of the image sensor of the camera head 1202 in synchronism with the timing of changing the intensity of the light, and combine the images, thereby generating an image of a high dynamic range without so-called shadow detail loss or highlight detail loss.

The light source apparatus 1203 may be configured to supply light in a predetermined wavelength band corresponding to special light observation. In special light observation, for example, the wavelength dependency of light absorption in the body tissue is used. More specifically, by performing irradiation with light in a narrow band, as compared with irradiation light (that is, white light) at the time of normal observation, predetermined tissue such as a blood vessel in the mucous membrane surface layer is captured with high contrast. Alternatively, in special light observation, fluorescence observation for obtaining an image by using fluorescence generated by performing irradiation with excitation light may be performed. In fluorescence observation, it is possible to, for example, irradiate body tissue with excitation light and observe fluorescence from the body tissue, or locally inject a reagent such as indocyanine green (ICG) into body tissue while irradiating the body tissue with excitation light corresponding to the fluorescence wavelength of the reagent, thereby obtaining a fluorescence image. The light source apparatus 1203 can be configured to supply narrow band light and/or excitation light corresponding to such special light observation.

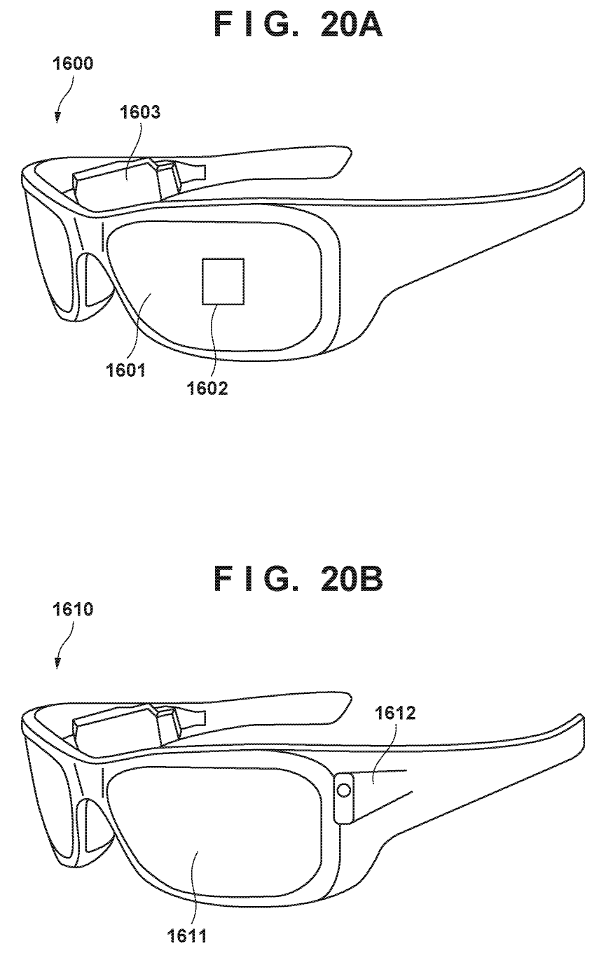

A photoelectric conversion system according to the fifth application example will be described with reference to FIGS. 20A and 20B. FIG. 20A illustrates glasses 1600 (smartglasses) as the photoelectric conversion system according to the fifth application example. The glasses 1600 include a photoelectric conversion apparatus 1602. The photoelectric conversion apparatus 1602 is the photoelectric conversion apparatus 100 (image capturing apparatus) described in each of the above embodiments. A display apparatus including the light emitting apparatus such as an OLED or LED may be provided on the back surface side of a lens 1601. One or a plurality of photoelectric conversion apparatuses 1602 may be provided. Alternatively, a plurality of kinds of photoelectric conversion apparatuses may be used in combination. The arrangement position of the photoelectric conversion apparatus 1602 is not limited to that shown in FIG. 20A.

The glasses 1600 further include a control apparatus 1603. The control apparatus 1603 functions as a power supply that supplies electric power to the photoelectric conversion apparatus 1602 and the above-described display apparatus. In addition, the control apparatus 1603 controls the operations of the photoelectric conversion apparatus 1602 and the display apparatus. An optical system configured to condense light to the photoelectric conversion apparatus 1602 is formed on the lens 1601.

FIG. 20B illustrates glasses 1610 (smartglasses) according to an application example. The glasses 1610 include a control apparatus 1612, and a photoelectric conversion apparatus corresponding to the photoelectric conversion apparatus 1602 and a display apparatus are mounted on the control apparatus 1612. The photoelectric conversion apparatus in the control apparatus 1612 and an optical system configured to project light emitted from the display apparatus are formed in a lens 1611, and an image is projected to the lens 1611. The control apparatus 1612 functions as a power supply that supplies electric power to the photoelectric conversion apparatus and the display apparatus, and controls the operations of the photoelectric conversion apparatus and the display apparatus. The control apparatus may include a line-of-sight detection unit that detects the line of sight of a wearer. The detection of a line of sight may be done using infrared light. An infrared light emitting unit emits infrared light to an eyeball of the user who is gazing at a displayed image. An image capturing unit including a light receiving element detects reflected light of the emitted infrared light from the eyeball, thereby obtaining a captured image of the eyeball. A reduction unit for reducing light from the infrared light emitting unit to the display unit in a plan view is provided, thereby reducing deterioration of image quality.

The line of sight of the user to the displayed image is detected from the captured image of the eyeball obtained by capturing the infrared light. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The display apparatus according to this application example can include a photoelectric conversion apparatus including a light receiving element, and control a displayed image of the display apparatus based on the line-of-sight information of the user from the photoelectric conversion apparatus.

More specifically, the display apparatus decides a first visual field region at which the user is gazing and a second visual field region other than the first visual field region based on the line-of-sight information. The first visual field region and the second visual field region may be decided by the control apparatus of the display apparatus, or those decided by an external control apparatus may be received. In the display region of the display apparatus, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority may be decided from the first display region and the second display region based on line-of-sight information. The first visual field region and the second visual field region may be decided by the control apparatus of the display apparatus, or those decided by an external control apparatus may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target object ahead the line of sight from the image of the eyeball using the image of the eyeball and the direction of actual viewing of the eyeball in the image as supervised data. The AI program may be held by the display apparatus, the photoelectric conversion apparatus, or an external apparatus. If the external apparatus holds the AI program, it is transmitted to the display apparatus via communication.

When performing display control based on line-of-sight detection, smartglasses further including a photoelectric conversion apparatus configured to capture the image of the outside can preferably be applied. The smartglasses can display the captured outside image information in real time.

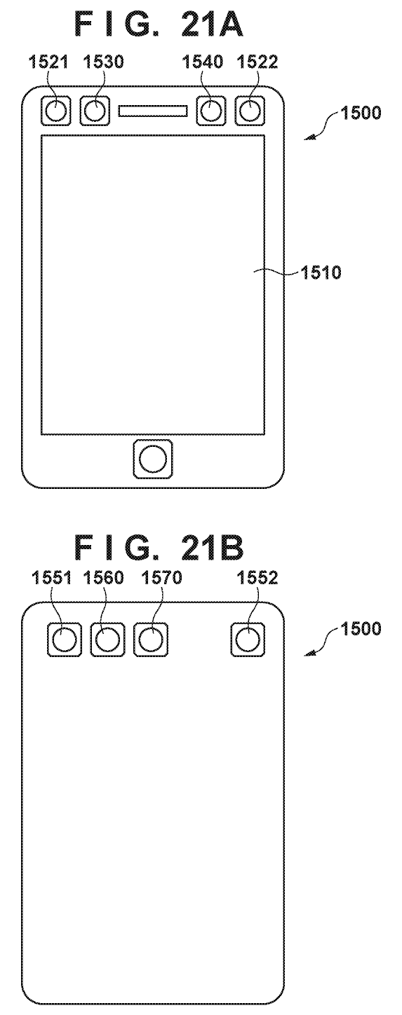

The sixth application example will be described with reference to FIGS. 21A and 21B. The above-described photoelectric conversion apparatus and photoelectric conversion system may be applied to, for example, electronic equipment such as a so-called smartphone or tablet.

FIGS. 21A and 21B are views showing an example of electronic equipment 1500 on which the photoelectric conversion apparatus is mounted. FIG. 21A shows the front surface side of the electronic equipment 1500, and FIG. 21B shows the back surface side of the electronic equipment 1500.

As shown in FIG. 21A, a display 1510 that displays an image is arranged at the center of the front surface of the electronic equipment 1500. Then, front cameras 1521 and 1522 for each of which the above-described photoelectric conversion apparatus 100 is used, an IR light source 1530 that emits infrared light, and a visible light source 1540 that emits visible light are arranged along the upper side of the front surface of the electronic equipment 1500.

As shown in FIG. 21B, rear cameras 1551 and 1552 for each of which the above-described photoelectric conversion apparatus 100 is used, an IR light source 1560 that emits infrared light, and a visible light source 1570 that emits visible light are arranged along the upper side of the back surface of the electronic equipment 1500.

By applying the above-described photoelectric conversion apparatus 100, the electronic equipment 1500 having the above arrangement can capture, for example, an image of higher quality. Note that the photoelectric conversion apparatus can be applied to electronic equipment such as an infrared sensor, a distance measurement sensor using an active infrared source, a security camera, or a personal or biometric authentication camera. This can improve the accuracy and performance of the electronic equipment.

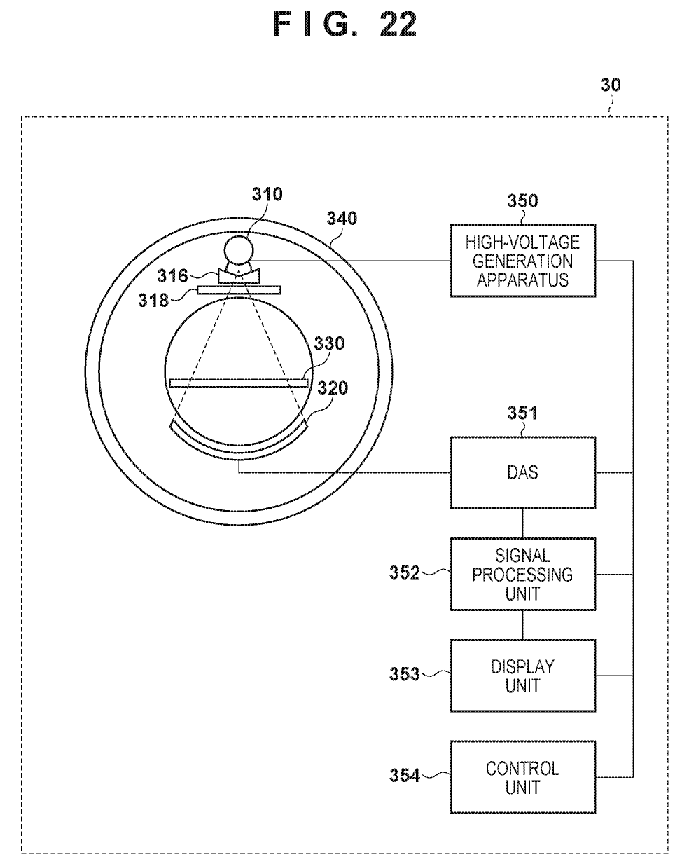

FIG. 22 is a block diagram of an X-ray CT apparatus according to the seventh application example. The above-described photoelectric conversion apparatus 100 is applicable to a detector of the X-ray CT apparatus. An X-ray CT apparatus 30 according to this application example includes an X-ray generation unit 310, a wedge 316, a collimator 318, an X-ray detection unit 320, a top plate 330, a rotating frame 340, and a high-voltage generation apparatus 350. The X-ray CT apparatus 30 also includes a Data Acquisition System (DAS) 351, a signal processing unit 352, a display unit 353, and a control unit 354.

The X-ray generation unit 310 is formed from, for example, a vacuum tube that generates X-rays. The vacuum tube of the X-ray generation unit 310 is supplied with a filament current and a high voltage from the high-voltage generation apparatus 350. When thermoelectrons are emitted from a cathode (filament) to an anode (target), X-rays are generated.

The wedge 316 is a filter that adjusts the amount of X-rays emitted from the X-ray generation unit 310. The wedge 316 attenuates the amount of X-rays so that the X-rays emitted from the X-ray generation unit 310 to an object have a predetermined distribution. The collimator 318 is formed from a lead plate that narrows the irradiation range of the X-rays having passed through the wedge 316. The X-rays generated by the X-ray generation unit 310 are formed in a cone beam shape via the collimator 318, and the object on the top plate 330 is irradiated with the X-rays.

The X-ray detection unit 320 is formed using the above-described photoelectric conversion apparatus 100. The X-ray detection unit 320 detects the X-rays having passed through the object from the X-ray generation unit 310, and outputs a signal corresponding to the amount of the X-rays to the DAS 351.

The rotating frame 340 is annular, and is configured to be rotatable. The X-ray generation unit 310 (the wedge 316 and the collimator 318) and the X-ray detection unit 320 are arranged to face each other in the rotating frame 340. The X-ray generation unit 310 and the X-ray detection unit 320 can rotate together with the rotating frame 340.

The high-voltage generation apparatus 350 includes a boosting circuit, and outputs a high voltage to the X-ray generation unit 310. The DAS 351 includes an amplification circuit and an A/D conversion circuit, and outputs, as digital data, a signal from the X-ray detection unit 320 to the signal processing unit 352.

The signal processing unit 352 includes a Central Processing Unit (CPU), a Read Only Memory (ROM), and a Random Access Memory (RAM), and can execute image processing and the like for the digital data. The display unit 353 includes a flat display apparatus or the like, and can display an X-ray image. The control unit 354 includes a CPU, a ROM, a RAM, and the like, and controls the operation of the overall X-ray CT apparatus 30.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020991, filed February 12, 2025, which is hereby incorporated by reference herein in its entirety.

What is claimed is:

1. A photoelectric conversion apparatus comprising:
a plurality of APDs;
a first control circuit configured to set the plurality of APDs in a photon-detectable state in accordance with a first control signal;
a plurality of shaping circuits supplied with outputs of the plurality of APDs, respectively;
a logic circuit configured to generate a second control signal by calculating a logical sum of outputs of the plurality of shaping circuits;
a counter configured to perform a count operation in a case where the second control signal is generated; and
a second control circuit configured to set the plurality of APDs in an avalanche non-occurrence state in a case where the second control signal is generated.

2. The apparatus according to claim 1, wherein
the second control circuit controls a voltage of an output terminal of each of the plurality of APDs.

3. The apparatus according to claim 2, wherein
the second control circuit includes a plurality of transistors configured to connect an output terminal of each of the plurality of APDs and a line applied with a predetermined voltage.

4. The apparatus according to claim 3, wherein
the plurality of transistors are controlled by the second control signal.

5. The apparatus according to claim 4, wherein
the logic circuit is an OR circuit, and
the plurality of transistors are NMOS transistors.

6. The apparatus according to claim 4, wherein
the logic circuit is a NOR circuit, and
the plurality of transistors are PMOS transistors.

7. The apparatus according to claim 1, further comprising a deactivation circuit configured to deactivate the second control circuit in accordance with a deactivation signal,
wherein the first control signal is a signal that transitions with a delay relative to transition of the deactivation signal.

8. The apparatus according to claim 7, further comprising a delay circuit configured to generate, as the first control signal, a delay signal with a delay relative to the deactivation signal.

9. The apparatus according to claim 1, wherein
the first control circuit further includes a plurality of level shifters connected in series to the plurality of APDs, respectively.

10. The apparatus according to claim 9, wherein
the plurality of level shifters are deactivated in a case where the second control circuit is activated, and are activated in a case where the second control circuit is deactivated.

11. The apparatus according to claim 10, wherein
each of the plurality of level shifters is a transistor.

12. The apparatus according to claim 11, wherein
the plurality of level shifters are arranged between the first control circuit and the plurality of APDs.

13. The apparatus according to claim 9, wherein
the second control circuit further includes a latch circuit configured to activate the second control circuit in a case where the second control signal is activated, and activate the plurality of level shifters when starting photon detection.

14. The apparatus according to claim 13, wherein
the latch circuit includes an SR latch circuit.

15. A photoelectric conversion system comprising:
a photoelectric conversion apparatus defined in claim 1; and
a signal processing unit configured to process a signal output from the photoelectric conversion apparatus.

16. A photoelectric conversion apparatus comprising:
first to fourth APDs;
a first control circuit configured to set the first to fourth APDs in a photon-detectable state in accordance with a control signal;
first to fourth shaping circuits configured to generate detection signals in accordance with outputs of the first to fourth APDs, respectively;
a first counter configured to perform a count operation in a case where the detection signal is generated by one of the first shaping circuit and the second shaping circuit;
a second counter configured to perform a count operation in a case where the detection signal is generated by one of the third shaping circuit and the fourth shaping circuit;
a third counter configured to perform a count operation in a case where the detection signal is generated by one of the first shaping circuit and the third shaping circuit;
a fourth counter configured to perform a count operation in a case where the detection signal is generated by one of the second shaping circuit and the fourth shaping circuit; and
a second control circuit configured to set the second APD and the third APD in an avalanche non-occurrence state in a case where the detection signals are generated by the first shaping circuit and the fourth shaping circuit, and set the first APD and the fourth APD in an avalanche non-occurrence state in a case where the detection signals are generated by the second shaping circuit and the third shaping circuit.

17. The apparatus according to claim 16, wherein
the first APD and the second APD form a pair for phase difference detection, and
the third APD and the fourth APD form a pair for phase difference detection.

18. The apparatus according to claim 16, wherein
the second control circuit controls voltages of output terminals of the first to fourth APDs, respectively.

19. The apparatus according to claim 17, wherein
the second control circuit includes a plurality of transistors configured to connect an output terminal of each of the first to fourth APDs and a line applied with a predetermined voltage.

20. A photoelectric conversion system comprising:
a photoelectric conversion apparatus defined in claim 16; and
a signal processing unit configured to process a signal output from the photoelectric conversion apparatus.
